(19) United States
(12) Patent Application Publication
(10) Pub. No.: US 2016/0034543 A1
(43) Pub. Date: Feb. 4, 2016

(54) GENERATING ITEM LISTINGS ACCORDING TO MAPPED SENSOR DATA

(71) Applicants: Vinay Rajashekar Nagar, San Jose, CA (US); Shweta Pogde, Sunnyvale, CA (US); Arun Selvaraj, San Jose, CA (US); Snigdha Mokkapati, Sunnyvale, CA (US); Venkatesh Sriram, Sunnyvale, CA (US); Suraj Chhetri, San Jose, CA (US)

(72) Inventors: Vinay Rajashekar Nagar, San Jose, CA (US); Shweta Pogde, Sunnyvale, CA (US); Arun Selvaraj, San Jose, CA (US); Snigdha Mokkapati, Sunnyvale, CA (US); Venkatesh Sriram, Sunnyvale, CA (US); Suraj Chhetri, San Jose, CA (US)

(21) Appl. No.: 14/585,100

(22) Filed: Dec. 29, 2014

Related U.S. Application Data
(60) Provisional application No. 62/032,915, filed on Aug. 4, 2014.

(51) Int. Cl. G06F 17/30; G06Q 30/06

(52) U.S. Cl. CPC G06F 17/30554; G06F 17/3053; G06Q 30/0627

(57) ABSTRACT

In various example embodiments, a mapping system and method for generating product listings for machine sensed and user specified criteria are presented. In example embodiments, sensor data about an object, and user characteristic information are received. Physical characteristics are extracted from the sensor data and mapped with the user characteristic information and related characteristics to create mapped characteristics. Based on the mapped characteristics, item listings are identified, ranked and presented to the user. The user can subsequently refine the search criteria by adding, subtracting or reweighing the characteristics.

### CROSS-REFERENCE TO RELATED APPLICATIONS

This application claims the benefit of U.S. Provisional Application No. 62/032,915, filed Aug. 4, 2014, entitled “GENERATING ITEM LISTINGS ACCORDING TO MAPPED SENSOR DATA,” which is incorporated herein by reference in its entirety.

### TECHNICAL FIELD

Embodiments of the present disclosure relate generally to sensing real world data about physical products and extracting information to facilitate electronic representation of the product, more particularly, but not by way of limitation, to generating product listings according to mapped sensor data.

### BACKGROUND

In recent years, mobile devices, wearable devices, smart devices, and the like have pervaded nearly every aspect of modern life. Such devices are increasingly incorporating sensors to monitor everything from the moisture level of houseplants to the dribbling of a basketball. Network connected devices like these are capable of providing a near real-time and constant data feed. These trends have provided a vast amount of rich, constantly updated data. A goal of this data collection is the subsequent development of various ways to employ the data to improve an individual's daily life.

### BRIEF DESCRIPTION OF THE DRAWINGS

Various ones of the appended drawings merely illustrate example embodiments of the present disclosure and cannot be considered as limiting its scope.

FIG. 1A is a block diagram illustrating a networked system, according to some example embodiments.

FIG. 1B illustrates a block diagram showing components provided within the system of FIG. 1A, according to some example embodiments.

FIG. 2 is a block diagram illustrating an example embodiment of a mapping system, according to some example embodiments.

FIG. 3 is a flow diagram illustrating an example method for intake and mapping of characteristics and generation of the item listings.

FIG. 4 is a flow diagram illustrating an example method for further refining search results responsive to a user input.

FIG. 5 is a flow diagram illustrating the mapping of characteristics in greater detail.

FIG. 6 is an example embodiment of a client device presenting product listings to a user along with refining options.

FIG. 7 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, systems and methods can be used to generate an item listing based on data collected by at least one sensor. In an example, at least one sensor could exist on a wearable device such as a head mounted display. The sensor can optionally be directed to receive data from a particular object within a user's surroundings.

Various systems and methods can be used to determine an object's physical characteristics, such as color or texture. In an example, that can include a mapping system, the mapping system can include an intake module configured to receive data. This data can include user characteristics received from a network, such as a user's purchase history, profile information, or preferences. This data can also include sensor data about a particular object, such as a flower.

The mapping system can further include an extraction module configured to extract at least one physical characteristic from the sensor data such as color, physical weight, density, texture, scent, or a category. In the above example, the extraction module can determine that the object is a purple (color), smooth (texture), faintly sweet (scent) flower (category).

The mapping system can include a mapping module configured to compare and map the physical characteristics derived from sensor data with previously collected user characteristics. The user characteristics can include, for example, purchase history, profile information, and selectable preferences. The mapped characteristics can correspond to a user's preference in what type of items should be generated for the user. In addition, the mapping system may collect from a network and include in the mapped characteristics not derived from either the user characteristics or the sensor data, but are related to the user or sensor data.

The mapping system can further include an identification module configured to use a network and various third-party applications to retrieve listings according to the mapped characteristics. Various networks and third-party sites can be used such as eBay, Google Shopping, Ali Express, etc. In addition to an identification module, the mapping system can optionally include a ranking module configured to rank the identified listings based on which listings most closely match the mapped characteristics.

Finally, the mapping system can include a presentation module configured to cause the ranked item listings to be presented to a user. The presentation to a user can occur using various client devices.

As an optional step, the user can take action to refine the search. The mapping module can respond to this input by adding, subtracting, or re-weighting the mapped characteristics. The above example is a non-limiting embodiment of how the mapping system can function to generate item listings for a user.

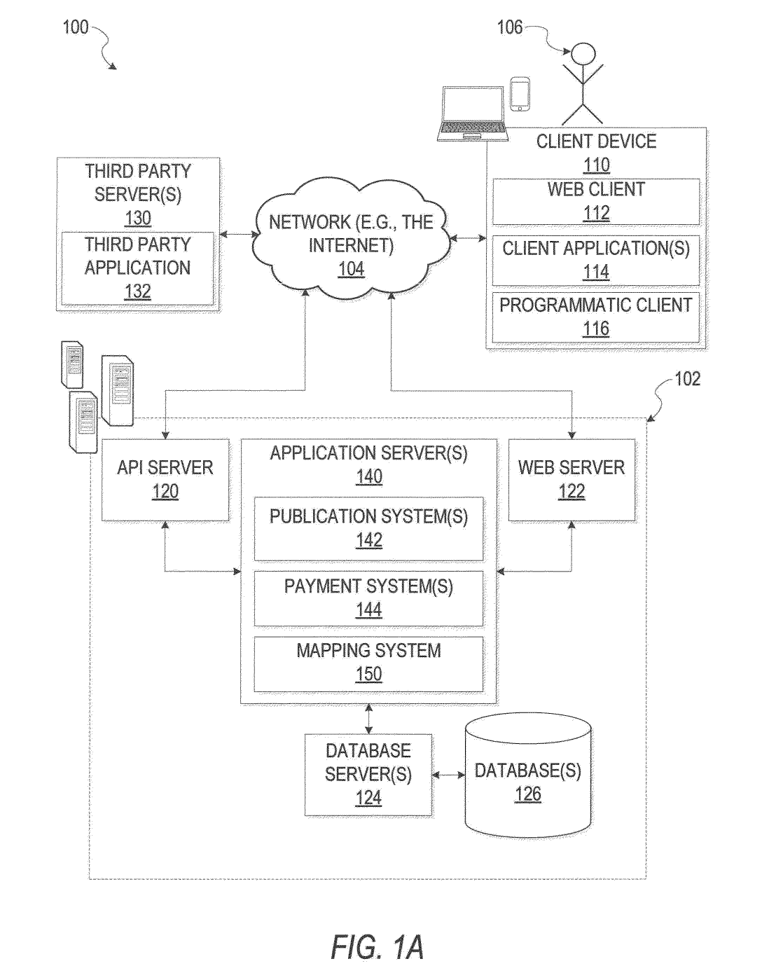

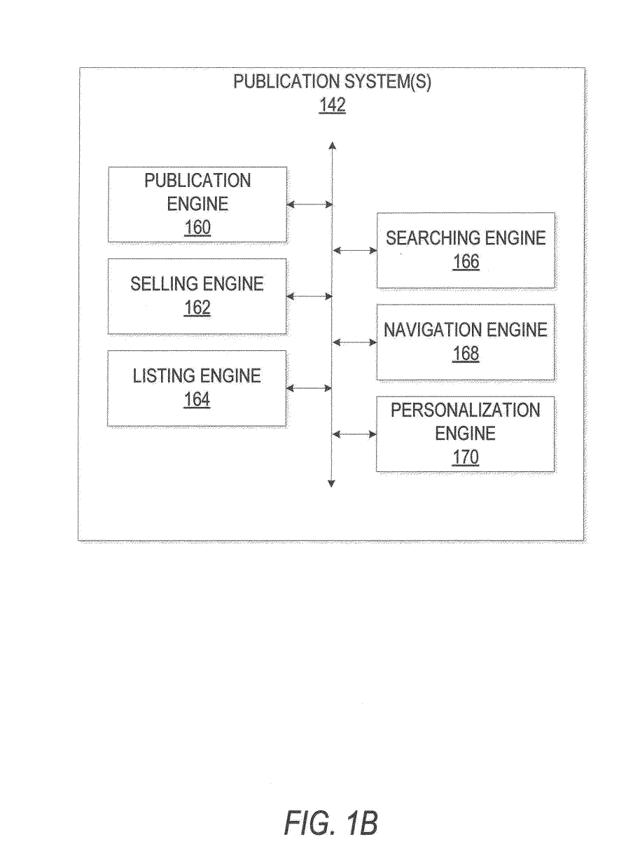

With reference to FIG. 1A, an example embodiment of a high-level client-server-based network architecture 100 is shown. A networked system 102 provides server-side functionality via a network 104 (e.g., the Internet or wide area network (WAN)) to a client device 110. A user (e.g., user 106) may interact with the networked system 102 using the client device 110. FIG. 1A illustrates, for example, a web client 112 (e.g., a browser, such as the Internet Explorer® browser developed by Microsoft® Corporation of Redmond, Wash. State), client application(s) 114, and a programmatic client 116 executing on the client device 110. The client device 110 may include the web client 112, the client application(s) 114, and the programmatic client 116 alone, together, or in any suitable combination. Although FIG. 1A shows one client device 110, multiple client devices may be included in the network architecture 100.

The client device 110 may comprise a computing device that includes at least a display and communication capabilities that provide access to the networked system 102 via the network 104. The client device 110 may comprise, but is not limited to, a remote device, work station, computer, general purpose computer, Internet appliance, hand-held device, wireless device, portable device, wearable computer, cellular or mobile phone, personal digital assistant (PDA), smart phone, tablet, ultrabook, netbook, laptop, desktop, multi-processor system, microprocessor-based or programmable consumer electronic, game consoles, set-top box, network PC, mini-computer, and the like. In further example embodiments, the client device 110 may comprise one or more of a touch screen, accelerometer, gyroscope, biometric sensor, camera, microphone, global positioning system (GPS) device, and the like.

The client device 110 may communicate with the network 104 via a wired or wireless connection. For example, one or more portions of the network 104 may be an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or a combination of two or more such networks.

The client device 110 may include one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and so on. The client application(s) 114 may include various components operable to present information to the user and communicate with networked system 102. In some embodiments, if the e-commerce site application is included in the client device 110, then this application may be configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely, if the e-commerce site application is not included in the client device 110, the client device 110 may use its web browser to access the e-commerce site (or a variant thereof) hosted on the networked system 102.

In various example embodiments, the users (e.g., the user 106) may be a person, a machine, or other means of interacting with the client device 110. In some example embodiments, the users may not be part of the network architecture 100, but may interact with the network architecture 100 via the client device 110 or another means. For instance, the users may interact with client device 110 that may be operable to receive input information from (e.g., using touch screen input or alphanumeric input) and present information to (e.g., using graphical presentation on a device display) the users. In this instance, the users may, for example, provide input information to the client device 110 that may be communicated to the networked system 102 via the network 104. The networked system 102 may, in response to the received input information, communicate information to the client device 110 via the network 104 to be presented to the users. In this way, the user may interact with the networked system 102 using the client device 110.

An Application Program Interface (API) server 120 and a web server 122 may be coupled to, and provide programmatic and web interfaces respectively to, one or more application server(s) 140. The application server(s) 140 may host one or more publication system(s) 142, payment system(s) 144, and a mapping system 150, each of which may comprise one or more modules or applications and each of which may be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information to be posted (e.g., publications or listings) to the publication system(s) 142. The database(s) 126 may also store digital goods information in accordance with some example embodiments.

Additionally, a third party application 132, executing on a third party server 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

The publication system(s) 142 may provide a number of publication functions and services to the users that access the networked system 102. The payment system(s) 144 may likewise provide a number of functions to perform or facilitate payments and transactions. While the publication system(s) 142 and payment system(s) 144 are shown in FIG. 1A to both form part of the networked system 102, it will be appreciated that, in alternative embodiments, each system 142 and 144 may form part of a payment service that is separate and distinct from the networked system 102. In some example embodiments, the payment system(s) 144 may form part of the publication system(s) 142.

The mapping system 150 may provide functionality to receive and map data. In some example embodiments, the mapping system 150 may communicate with the client device 110, the third party server(s) 130, the publication system(s) 142 (e.g., retrieving listings), and the payment system(s) 144 (e.g., purchasing a listing). The mapping system 150 can be configured to receive sensor data and user characteristics, extract physical characteristics from sensor data, map the physical characteristics with the user characteristics and related characteristics to create mapped characteristics, identify product listings associated with the mapped characteristics, rank the identified product listings, and cause the listings to be presented to a user. In an alternative example embodiment, the mapping system 150 may be a part of the publication system(s) 142.

Further, while the client-server-based network architecture 100 shown in FIG. 1A employs a client-server architecture, the present inventive subject matter is, of course, not limited to such an architecture, and may equally well find application in a distributed, or peer-to-peer, architecture system, for example. The various systems of the applications server(s) 140 (e.g., the publication system(s) 142 and the payment system(s) 144) may also be implemented as standalone software programs, which do not necessarily have networking capabilities.

The web client 112 may access the various systems of the networked system 102 (e.g., the publication system(s) 142) via the web interface supported by the web server 122. Similarly, the programmatic client 116 and client application(s) 114 may access the various services and functions provided by the networked system 102 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

FIG. 1B illustrates a block diagram showing components provided within the publication system(s) 142, according to some embodiments. In various example embodiments, the publication system(s) 142 may comprise a market place system to provide market place functionality (e.g., facilitating the purchase of items associated with item listings on an e-commerce website). The networked system 102 may be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more database(s) 126 via the database server(s) 124.

The networked system 102 may provide a number of publishing, listing, and price-setting mechanisms whereby a seller (also referred to as a “first user”) may list (or publish information concerning) goods or services for sale or barter, a buyer (also referred to as a “second user”) can express interest in or indicate a desire to purchase or barter such goods or services, and a transaction (such as a trade) may be completed pertaining to the goods or services. To this end, the networked system 102 may comprise a publication engine 160 and a selling engine 162. The publication engine 160 may publish information, such as item listings or product description pages, on the networked system 102. In some embodiments, the selling engine 162 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engine 162 may further comprise one or more deal engines that support merchant-generated offers for products and services.

A listing engine 164 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 164 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., database(s) 126). Listings also may comprise product description pages that display a product and information (e.g., product title, specifications, and reviews) associated with the product. In some embodiments, the product description page may include an aggregation of item listings that correspond to the product described on the product description page.

The listing engine 164 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 164 may receive as much or as little listing data, such as title, description, and aspect name/value pairs, that the buyer is aware of about the requested item. In some embodiments, the listing engine 164 may parse the buyer's submitted item information and may complete incomplete portions of the listing. For example, if the buyer provides a brief description of a requested item, the listing engine 164 may parse the description, extract key terms and use those terms to make a determination of the identity of the item. Using the determined item identity, the listing engine 164 may retrieve additional item details for inclusion in the buyer item request. In some embodiments, the listing engine 164 may assign an item identifier to each listing for a good or service.

In some embodiments, the listing engine 164 allows sellers to generate offers for discounts on products or services. The listing engine 164 may receive listing data, such as the product or service being offered, a price or discount for the product or service, a time period for which the offer is valid, and so forth. In some embodiments, the listing engine 164 permits sellers to generate offers from a sellers' mobile devices. The generated offers may be uploaded to the networked system 102 for storage and tracking.

Searching the networked system 102 is facilitated by a searching engine 166. For example, the searching engine 166 enables keyword queries of listings published via the networked system 102. In example embodiments, the searching engine 166 receives the keyword queries from a device of a user and conducts a review of the storage device storing the listing information. The review will enable compilation of a result set of listings that may be sorted and returned to the client device 110 of the user. The searching engine 166 may record the query (e.g., keywords) and any subsequent user actions and behaviors (e.g., navigations, selections, or click-throughs).

The searching engine 166 also may perform a search based on a location of the user. A user may access the searching engine 166 via a mobile device and generate a search query. Using the search query and the user's location, the searching engine 166 may return relevant search results for products, services, offers, auctions, and so forth to the user. The searching engine 166 may identify relevant search results both in a list form and graphically on a map. Selection of a graphical indicator on the map may provide additional details regarding the selected search result. In some embodiments, the user may specify, as part of the search query, a radius or distance from the user's current location to limit search results.

In a further example, a navigation engine 168 allows users to navigate through various categories, catalogs, or inventory data structures according to which listings may be classified within the networked system 102. For example, the navigation engine 168 allows a user to successively navigate down a category tree comprising a hierarchy of categories (e.g., the category tree structure) until a particular set of listings is reached. Various other navigation applications within the navigation engine 168 may be provided to supplement the searching and browsing applications. The navigation engine 168 may record the various user actions (e.g., clicks) performed by the user in order to navigate down the category tree.

In some example embodiments, a personalization engine 170 may allow the users of the networked system 102 to personalize various aspects of their interactions with the networked system 102. For instance, the users may define, provide, or otherwise communicate personalization settings that the personalization engine 170 may use to determine interactions with the networked system 102. In further example embodiments, the personalization engine 170 may automatically determine personalization settings and personalize interactions based on the automatically determined settings. For example, the personalization engine 170 may determine a native language of the user and automatically present information in the native language.

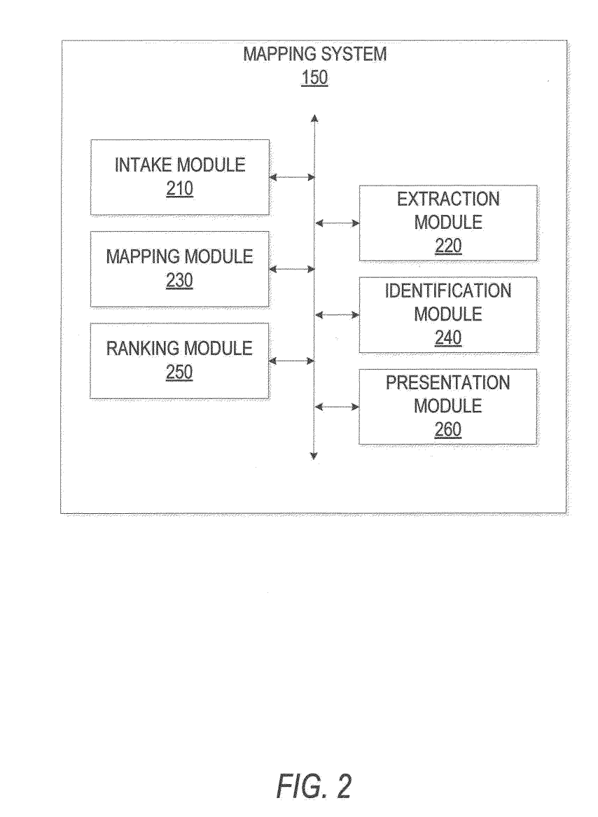

FIG. 2 is a block diagram of the mapping system 150, which may provide functionality to receive user characteristics and sensor data, extract physical characteristics from the sensor data, map the user characteristics and sensor data, identify item listings based on the user characteristics and sensor data, ranking the identified item listings based on the user characteristics and sensor data, and cause presentation of the identified and ranked item listings to a user, map user characteristics and sensor data and generate item listings.

In an example embodiment, the system 150 may include an intake module 210, an extraction module 220, a mapping module 230, an identification module 240, a ranking module 250, and a presentation module 260. All, or some, of the modules 210-260 of FIG. 2, may communicate with each other, for example, via a network coupling, shared memory, and the like.

It will be appreciated that each module of modules 210-260 may be implemented as a single module, combined into other modules, or further subdivided into multiple modules. Other modules not pertinent to example embodiments may also be included, but are not shown.

An intake module 210 can be capable communicating and retrieving this data over the networked system 102 or the network generally 104. Data retrieved by the intake module 210 may comprise data associated with the user. Such information can include the purchase history of the user. In a non-limiting example, if the user buys a pair of Ray Ban sunglasses, data may be generated notating the purchase. Such information in this could example could indicate a preference by the user for Ray Ban sunglasses or sunglasses generally.

Data retrieved by the intake module 210 associated with the user can further include user profile information such as a user's gender, age, location, marital status, etc. In addition to demographic information, the intake module 210 can also receive personal information such as height, weight, hair color, skin tone, etc. In a non-limiting example, a user may purchase makeup products for cosmetic purposes and include his or her skin tone in a user profile. The intake module 210 could retrieve data about the user's skin tone from the user's profile.

Data retrieved by the intake module 210 associated with the user can further include information about a user's search preferences. In a non-limiting example, a client or third-party application can receive data from the user corresponding to the user's preferences about an object's attributes, such as brand, color, shape, style, etc. If a user is shopping for a used car on a client application, the user may elect to only view mid-size sedans with a model year of 2008-2011. These preferences can be transmitted to and received by the intake module 210.

In addition to data associated with a user, the intake module 210 can retrieve sensor data about an object from at least one sensor. A sensor can include any mechanism that acquires information about a user's surroundings. Sensors may be capable of being worn or carried by a user and may exist as a component of or coupled with other devices. For example, a user may have an infrared depth sensor on a bracelet or an image recognition application on a mobile device.

In addition to a variety of sensors, sensor data can various forms of information. As discussed above, a user may instruct at least one sensor to collect information from a flower. In this example, a photo-analyzer can collect data about the color hue of the flower, an olfactory sensor can collect data about the scent of the flower, a scale-type sensor can collect information about the physical weight or mass of the flower, a tactile sensor can collect information about the firmness of the flower's petals, and an image recognition sensor can collect information confirming that object is a flower, etc. This example is non-limiting and various other types of sensors may be used. This sensor data can be retrieved from a network by the intake module 240 for analysis by the mapping system 150.

After retrieval by the intake module 210 the sensor data may be transmitted to an extraction module 220. The extraction module 220 can be capable of extracting discrete physical characteristics from the sensor data. For example, the extraction module may receive sensor data about the color and texture of a shirt. The sensor data may indicate that the shirt has a color at a specific numerical point on the visual spectrum, the material of the shirt produces specific auditory feedback when scratched, and the texture of the shirt produces a certain amount of friction when touched. The extraction module 220 can be configured to determine that the specific numerical point on the visual spectrum corresponds to a navy blue hue and the auditory and friction data corresponds to characteristics of a knit fabric. The extraction module 220 can thus determine that two characteristics of the shirt are that it is of navy blue hue and it has knit fabric.

A mapping module 230 may be configured to receive and map user characteristics from the intake module in the form of data characteristics 210 and physical characteristics from the extraction module 220. Using various algorithms and predetermined settings, the mapping module 230 can score each data and physical characteristic. The mapping module 230 can be configured to create mapped characteristics out of data and physical characteristics by weighting each data and physical characteristic according to its score. In addition, the mapping module 230 can be configured to add additional weighted characteristics to the mapped characteristics.

In an example, the mapping module 230 may receive various user characteristics from the intake module 210, including that a user is a 35 year old married female, wears a medium shirt size, and has purchased $600 worth of merchandise at Target.com in the past 12 months, and has specified that she likes Nike brand workout gear. In addition, the user may direct at least one sensor to an article of clothing she finds while shopping at a sports specialty store. The mapping module 230 may receive various physical characteristics about the article of clothing from the extraction module 220 including that the article is a long-sleeve workout shirt made of 65% polyester and 35% spandex and having a lime green hue. The mapping module 230 can score each characteristic according to how essential the characteristic is to generating accurate results. Using arbitrary numbers for the purpose of an example, the medium shirt size characteristic may receive a score of 95 and the Nike brand characteristic may receive a score of 30 since the user is much less likely to purchase a product that is not her size verses a non-Nike product.

The mapping module 230 can assign a weight to each characteristic based on the characteristic's score in relation to the scores of other characteristics using various algorithms or customizable preferences. A customizable preference in this context can be a user specifically designating a characteristic to be highly relevant. In this example, the user In the above example, at least one algorithm or customizable preference may determine the weight of Nike is 3, the weight of medium shirt size is 9, the 65% polyester and 35% spandex is 5, and the weight of lime green is 3.

In addition to weighting characteristics collected from the intake module 210 and the extraction module 220, the mapping module 230 may optionally add at least one additional related characteristic. For example, in the above example, a physical characteristic is 65% polyester and 35% spandex fabric with a weight of 5. The mapping module 230 may add a similar characteristic: 75% polyester and 25% spandex fabric with a weight of 3. In a similar manner, the mapping module may add the characteristic “kelly green” and assign it a weight of 1.

An identification module 240 may be configured to identify relevant item listings on a network, client application, or third-party application based on the listings matching the mapped physical, user, and relevant characteristics (mapped characteristics). In some embodiments, the identification module 240 can communicate with the listing engine 164 and other components of the networked system 102 to identify item listings. A quantity of listings having at least one mapped characteristic can be identified by the identification module 240, collected, and transmitted to a ranking module 250.

The ranking module 250 may be configured to score characteristics of the item listings based on the weight of a matching mapped characteristic. For example, if a user characteristic is that a user wears a size small shirt and the characteristic is weighted at 5, an item listing for a small shirt would be awarded a score 5 for that characteristic. The ranking module 250 can award additional “points” for other matching characteristics. The ranking module 250 can further rank the item listings from highest score to lowest score.

The presentation module 260 may be configured provide various presentation and user interface functionality operable to interactively present and receive information from users. For example, the presentation module 260 may cause presentation of the ranked item listings to a user. The presentation module 260 may present or cause presentation of information using a variety of means including visually displaying information and using other device outputs (e.g., acoustic, haptic). Interactively presenting is intended to include the exchange of information between a device and a user. The user may provide input to interact with the user interface in a variety of ways including alphanumeric input, cursor input, tactile input, or other input (e.g., one or more touch screen, camera, tactile sensors, light sensors, infrared sensors, biometric sensors, microphone, gyroscope, accelerometer, or other sensors). It will be appreciated that the presentation module 210 may provide many other user interfaces to facilitate functionality described herein. Further, it will be appreciated that “presenting” as used herein is intended to include communicating information to another device with functionality operable to perform presentation using the communicated information.

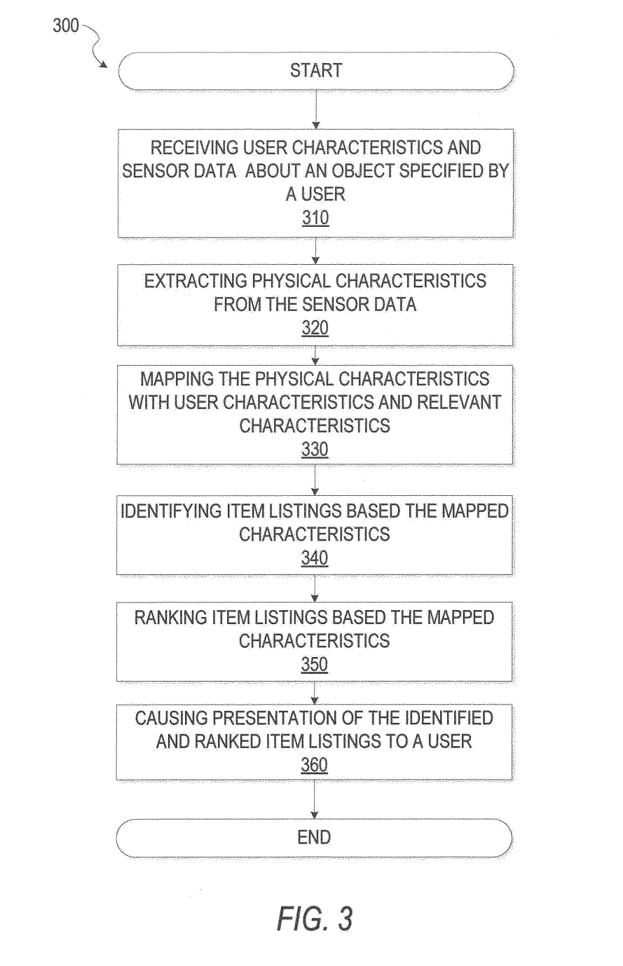

FIG. 3 is a flow diagram illustrating an example method 300 for the mapping system 150. As described in the preceding paragraphs, the invention can function by first receiving user characteristics and sensor data about an object specified by a user 310. These characteristics can be received over a network from various client applications and third party applications using an intake module 210.

The invention further functions by extracting physical characteristics from the sensor data 320. As described above, this can include using numerical sensor data to derive textual physical characteristics. For example, the extraction module may equate numerical density of an object's material with the density of aluminum, and therefore determine that the object has a physical characteristic of being aluminum.

The invention further functions by mapping the physical characteristics with user characteristics and relevant characteristics 330. The invention can map characteristics by scoring and weighting characteristics based on data received by the networked system 102 or network 104 generally.

The invention further functions by identifying 340 and ranking 350 item listings on a networked system 102 or network 104 based on the mapped characteristics. The ranking characteristics can be accomplished by aggregating the total weight of mapped characteristics displayed in a listing, assigning a score, and generating a list of item listings ranked by score.

The invention further functions by causing presentation of the identified and ranked item listings to a user. The presentation to the user can be accomplished using a variety of means including visually displaying information and using other device outputs (e.g., acoustic, haptic).

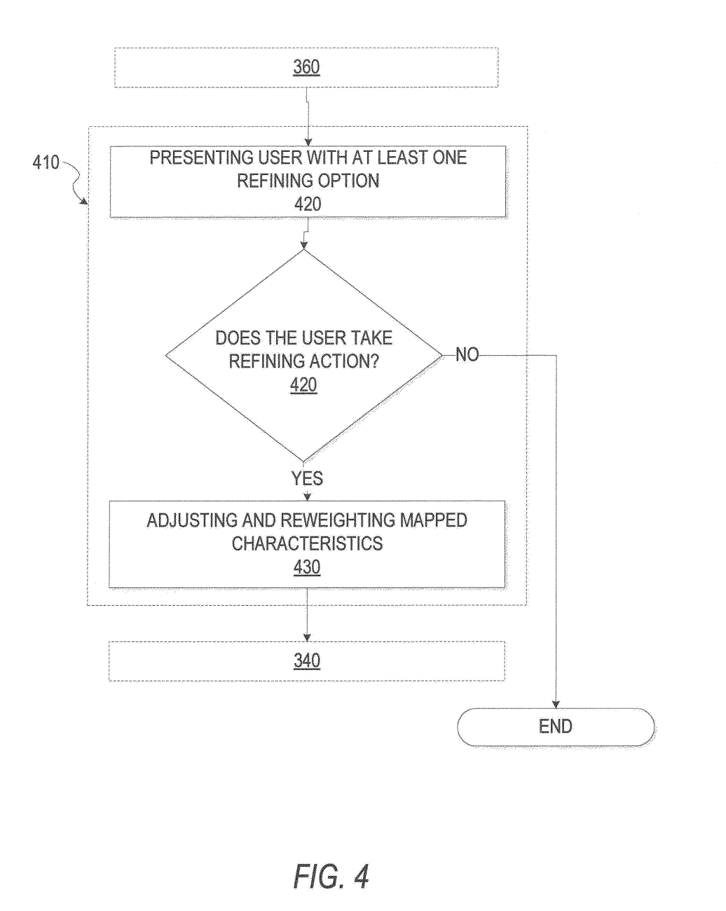

FIG. 4 is a flow diagram illustrating an example method 410 of the inventive subject matter's reaction to user-initiated refining input. In the step, the user can be presented with an option to further refine the search based upon one or more characteristics by adjusting and reweighting the mapped characteristics. For example, the user may decide to take refining action 420 on a search and choose to have a greater focus on color. The invention can respond by adding, subtracting or reweighting the mapped characteristics 430, in this example, giving a greater weight to color. The newly mapped characteristics can then proceed to the identification step 340, ranking step 350, and presentation step 360.

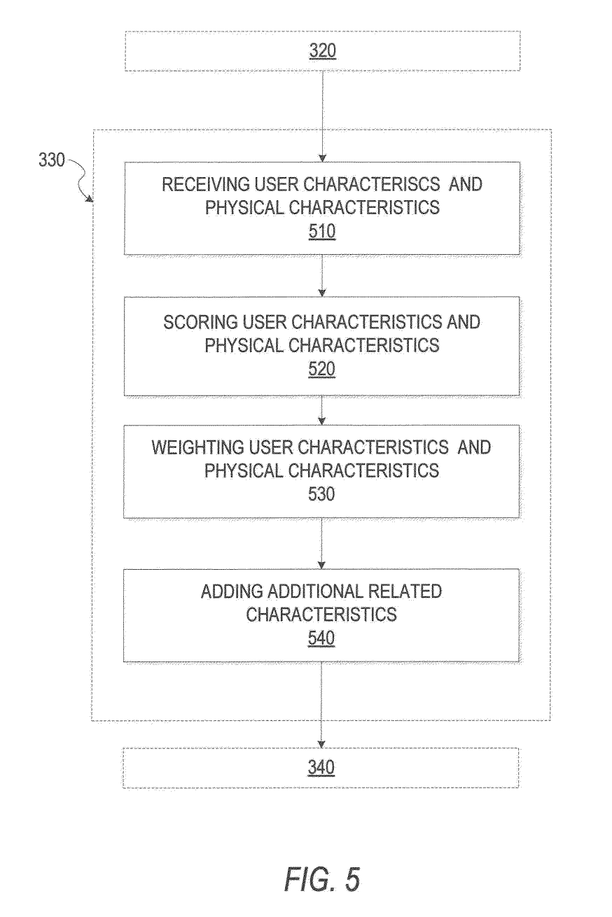

FIG. 5 is a flow diagram illustrating an example method of how the user, physical, and related characteristics can be mapped. Physical characteristics and data characteristics can be received separately 510. The physical characteristics and data characteristics can then be scored 520, for example out of 100, based on how essential the characteristic is for related to the user. The scores of the characteristics can then be compared to determine a relative weight for each characteristic 530. Additional characteristics related to the received physical and data characteristics can be added, scored, and weighted 540 to create a final quantity of mapped characteristics.

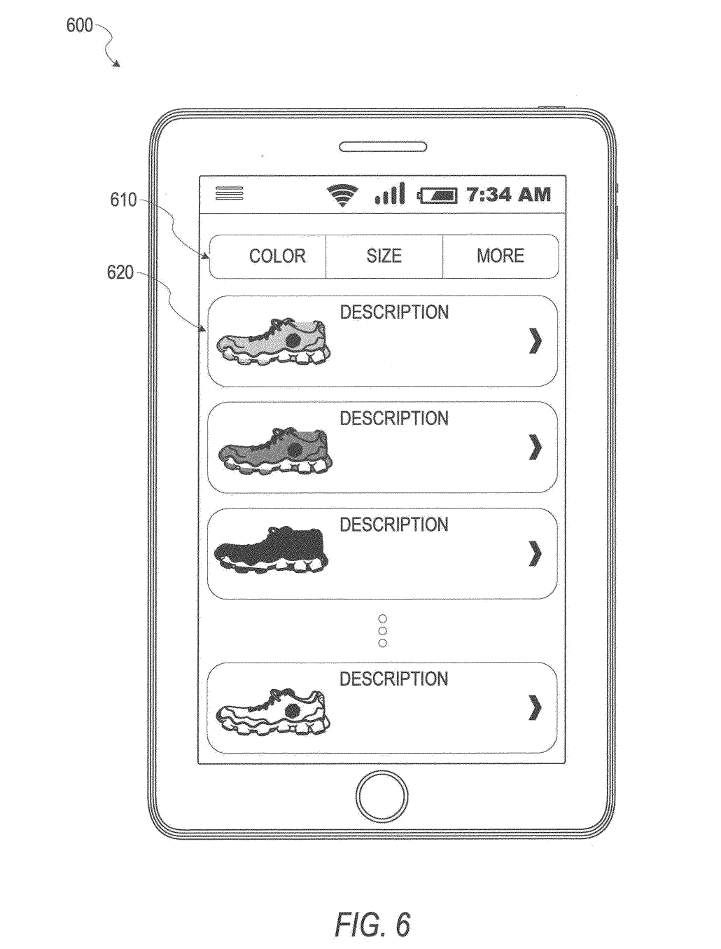

FIG. 6 is an example embodiment of how the presentation module 260 may cause presentation of the item listings to a user using a client device 600. The client device 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, or any device capable of causing presentation of item listings to a user.

The client device 600 may include refining options 610 actionable by the user and item ranked listings 620. The refining options 610 can allow the user to refine the search by instructing the mapping system to give additional weight to specific characteristics. Further, the mapping system can assign new weights to related characteristics. In an example, if a mapped characteristic for “lime green” had a weight of 5 and the user refines his or her search based on color, “lime green” may be assigned a higher weight of 10 and related mapped characteristics such as “kelly green” may also be given additional weight.

In an alternative embodiment, a user can employ the mapping system to add physical characteristics to listing for an item. The user can use at least one sensor to gather sensor data. The sensor data can be collected by the intake module 210, extracted by the extraction module 220 which can determine physical characteristics from sensor data, and added to an item listing specified by the user on a networked system 102 or third party application. In this way, the listing can be made available for other viewers to search using physical characteristics.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

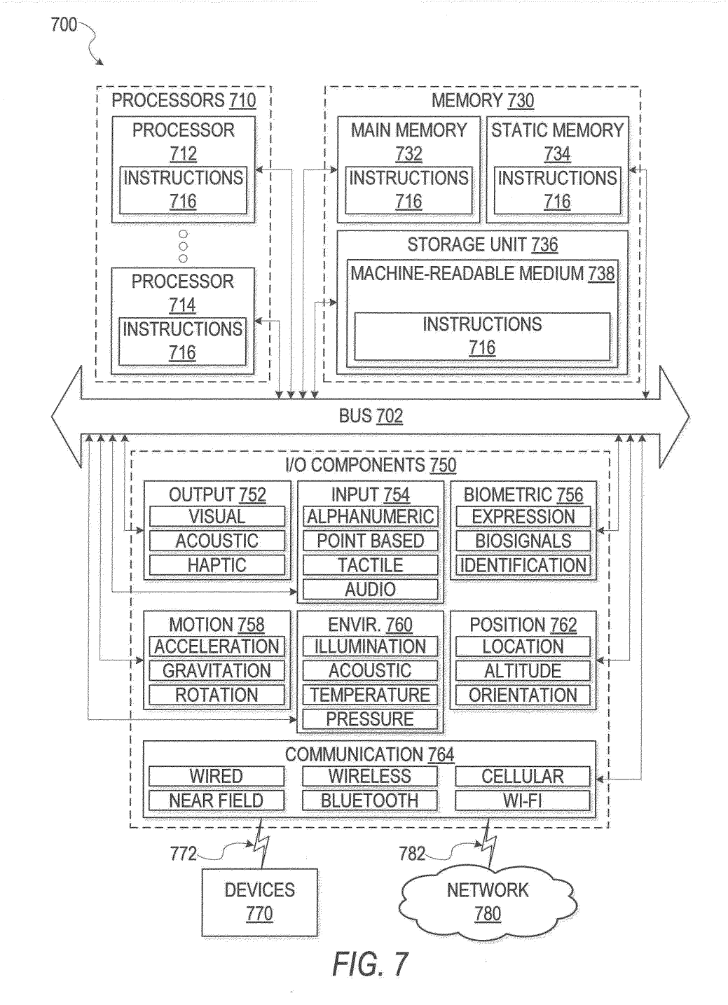

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (also referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory 730 may include a main memory 732, a static memory 734, and a storage unit 736 accessible to the processors 710 via the bus 702. The storage unit 736 may include a machine-readable medium 738 on which is stored the instructions 716 embodying any one or more of the methodologies or functions described herein. The instructions 716 may also reside, completely or at least partially, within the main memory 732, within the static memory 734, within at least one of the processors 710 (e.g., within the processor's cache memory), or any suitable combination thereof, during execution thereof by the machine 700. Accordingly, the main memory 732, static memory 734, and the processors 710 may be considered as machine-readable media 738.

As used herein, the term “memory” refers to a machine-readable medium 738 able to store data temporarily or permanently and may be taken to include, but not be limited to, random-access memory (RAM), read-only memory (ROM), buffer memory, flash memory, and cache memory. While the machine-readable medium 738 is shown in an example embodiment to be a single medium, the term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 750 may include a wide variety of components to receive input, provide output, produce output, transmit information, exchange information, capture measurements, and so on. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

Furthermore, the machine-readable medium 738 is non-transitory (in other words, not having any transitory signals) in that it does not embody a propagating signal. However, labeling the machine-readable medium 738 as “non-transitory” should not be construed to mean that the medium is incapable of movement; the medium should be considered as being transportable from one physical location to another. Additionally, since the machine-readable medium 738 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A mapping system comprising:
an intake module to receive first user characteristic information and sensor data from at least one sensor associated with an object specified by a user;
an extraction module to extract at least one physical characteristic from the sensor data,
a mapping module, using at least one processor of a machine, to map the at least one physical characteristic derived from the sensor data with the user characteristic information;
an identification module to identify item listings based on the mapped at least one physical characteristic and user characteristic information;
a ranking module to rank item listings based on the mapped at least one physical characteristic; and
a presentation module to cause presentation of the identified and ranked item listings to the user.

2. The system of claim 1, wherein user characteristic information includes purchase history, profile information, and selectable preferences.

3. The system of claim 1, wherein the sensor includes a pigment photo-analyzer and the sensor data includes information about a color of the object.

4. The system of claim 1, wherein the sensor includes a depth photo-analyzer and the sensor data includes information about a shape of the object.

5. The system of claim 1, wherein the sensor includes an olfactory sensor and the sensor data includes information about a scent of the object.

6. The system of claim 1, wherein the sensor includes a scale-type sensor and the sensor data includes information about the physical weight of the object.

7. The system of claim 1, wherein the sensor includes a tactile sensor and the sensor data includes information about a texture of the object.

8. The system of claim 1, wherein the sensor includes a density sensor and the sensor data includes information about a density of the object.

9. The system of claim 1, wherein the user characteristic information includes an implicit or explicit user preference in a profile of the user.

10. The system of claim 1, wherein the at least one physical characteristic includes color, scent, physical weight, density, texture, and object category.

11. The system of claim 1, wherein a user can subsequently add, subtract or reweight characteristics in order to further refine the search.

12. A method comprising:
receiving, using a processor of a machine, user characteristics and sensor data from at least one sensor about an object specified by a user;
extracting physical characteristics from the sensor data;
mapping the physical characteristics with user characteristics and related characteristics;
identifying item listings based on the mapped physical characteristics and user characteristics;
ranking item listings based on the mapped physical characteristics and user characteristics; and
causing presentation of the identified and ranked item listings to the user.

13. The method described in claim 12, wherein user characteristics include purchase history, profile information, and selectable preferences.

14. The method of claim 12, wherein a sensor includes a pigment photo-analyzer and sensor data includes information about an object's color.

15. The method of claim 12, wherein a sensor includes a depth photo-analyzer and sensor data includes information about an object's shape.

16. The method of claim 12, wherein a sensor includes an olfactory sensor and sensor date includes information about an object's scent.

17. The method of claim 12, wherein a sensor includes a scale-type sensor and sensor date includes information about an object's physical weight.

18. The method of claim 12, wherein a sensor includes a tactile sensor and sensor data includes information about an object's texture.

19. The method of claim 12, wherein a sensor includes a density sensor and sensor data includes information about an object's density.

20. The method of claim 12, wherein user characteristics include implicit or explicit user preferences from the user's profile information, purchase history, and other resources.

21. The method of claim 12, wherein physical characteristics include color, scent, physical weight, density, texture, and object category.

22. The method of claim 12, wherein user characteristics include implicit or explicit user preferences from the user's profile information, purchase history, and other resources.

23. The method of claim 12, wherein a user can subsequently add, subtract or reweight characteristics in order to further refine the search.
